(19) United States
(12) Patent Application Publication
(10) Pub. No.: US 2016/0194053 A1
(43) Pub. Date: Jul. 7, 2016

(54) MOUNTING SYSTEM FOR ATTACHING AN ELECTRIC SYSTEM TO BICYLCES

(71) Applicant: EGO SPORTS GMBH, Eugendorf (AT)

(72) Inventors: Mario PREINING, Linz-Urfahr (AT); Daniel PREINING, Salzburg (AT)

(73) Assignee: EGO Sports GmbH, Eugendorf (AT)

(21) Appl. No.: 14/909,448

(22) PCT Filed: Aug. 4, 2014
(86) PCT No.: PCT/EP2014/066739

§ 371 Date: Feb. 1, 2016

(30) Foreign Application Priority Data
Aug. 2, 2013 (AT) GM 252/2013

(51) Int. Cl. B62M 6/55; F16M 13/02; B62M 6/45

(52) U.S. Cl. CPC B62M 6/55; B62M 6/45; F16M 13/02

(57) ABSTRACT

The invention relates to a mounting system for mounting a drive unit on a bicycle frame, wherein the mounting system comprises an adapter which consists of at least one part, but preferably of two parts (7, 8), and which has variable attachment points (9, 10), to which a drive unit (comprising a motor and a controller) is fastened, wherein the adapter can be fastened on the bicycle frame using the attachment elements (12).

### FIELD OF THE INVENTION

The invention relates to a mounting system for a drive unit, which allows mounting a drive unit on a vehicle frame, preferably bicycles with attachments provided for this purpose, with few steps. The dismounting can also be quickly accomplished with few steps, if required.

### BACKGROUND OF THE INVENTION

All electric drive systems for bicycles found on the market are permanently connected to the frame such that the electric drive becomes a fixed integral part of the drive of the bicycle.

If at all possible, the dismounting of the electric drive system is time consuming and elaborate. Hence, in many cases, use as a normal bicycle is no longer possible or at least not without a significant effort.

To date there is no bicycle that can be at the same time a normal bicycle and with few steps an e-bike and hence benefits of the advantages of both variants.

This mounting system of an electric drive unit forms the technical background for such a transformation ability.

It is therefore the object of the present invention to provide a mounting system, which simplifies the mounting and dismounting of an electric drive system to a bicycle.

This object is accomplished by the mounting system as defined in the claims.

### SUMMARY OF THE INVENTION

A mounting system according to the present invention, which serves to mount a drive unit to a bicycle frame, comprises a one or two-part adapter and attachment elements. The adapter is provided with seatings for the attachment elements, which serve to non-positively mount the adapter to the attachment points provided on the bicycle frame.

If the adapter is embodied as a two-part adapter, both adapter elements are preferably disposed on opposite sides of the frame tube and are each either connected to the frame on the attachment points or connected to each other through the attachment points. If the adapter is embodied as a one-part adapter, it is preferably connected to the frame at the attachment points. A one-part adapter is preferably mounted at the drive side of the drive unit to better absorb the acting forces. The attachment points are preferably located on the lower tube of the bicycle frame near the bottom bracket.

In a preferred embodiment the attachment elements comprise thru axles with or without thread. The thru axles are formed to be inserted through attachment points provided in the bicycle frame as flushed sleeves through the frame. As thru axles quick-release axles may be employed.

In a further preferred embodiment at least several seatings comprise thread for the attachment elements or other non-positive seatings for the thru axles. For example, one seating may comprise a thread in the first adapter part, into which a corresponding thread of a quick-release axle is screwed. The corresponding seating in the other part of the adapter may be formed without a thread and may guide the quick-release axle non-positively. Both adapter parts may then be non-positively connected to the bicycle frame using a quick-release lever.

In a further preferred embodiment the attachment elements comprise bolts. These are formed to fasten the adapter on the attachment points provided on the bicycle frame as surficial thread.

In a further preferred embodiment the adapter is provided with seatings for fastening elements, which serve to non-positively fasten the drive unit on the adapter. For example, seating holes may be provided in the adapter for bolts that fasten the drive unit on the adapter.

In a further preferred embodiment at least one adapter part is integrally formed with a housing of the drive unit. In case the adapter is formed as a one-part adapter this may be the adapter itself. In case the adapter is formed as a two-part adapter either one of the adapter parts or both adapter parts may be integrally formed with a housing of the drive unit.

In a further preferred embodiment the adapter is provided with seatings for fastening elements, which serve to non-positively fasten an energy storage device, e.g. a battery or an accumulator, on the adapter. For example, seating holes may be provided in the adapter for quick-release axles, which extend through openings of the housing of the energy storage device and connect the energy storage device to the adapter. Accordingly, a quick replacement of the energy storage device is possible, e.g. when it is depleted. Alternatively, seating holes may be provided in the adapter for bolts that attach the energy storage device on the adapter.

According to the invention it is also provided that corresponding retaining elements (e.g. rails and/or guides) are provided on the adapter and the bicycle frame, which allow fastening the adapter on the bicycle frame by sliding the adapter along the retaining elements. The adapter may also be formed such that the energy storage device is also slid onto a rail, for example above and/or below the frame tube. The adapter having retaining elements may be already integrated in the frame tube or alternatively may be welded to the frame tube.

The invention further relates to a drive system for a bicycle with a drive unit, in particular an electric drive unit, which comprises a motor and a controller to control the motor. Furthermore, the drive system comprises a mounting system for mounting the drive unit on a bicycle frame, as described in the above. The aforementioned embodiments accordingly also apply to the drive system.

Particularly preferred the controller is permanently connected to the motor. In particular, the controller housing may be permanently connected, for example screwed, to the motor housing. The controller housing and motor housing may also be integrally formed. For example, the controller housing may be disposed on the motor housing such that it is located at the front (i.e. in driving direction at the front) or at the back (i.e. in driving direction at the back) of the motor that is mounted to the bicycle.

The technical innovation of this invention is the mounting of an electric drive system on a vehicle frame, preferably of a bicycle, which frame already comprises at least one, preferably two corresponding attachment points provided by the manufacturer, within a matter of minutes.

The adapter consists of at least one part, preferably two or more parts, and is embodied such that it may be screwed with the motor or may be integrally formed with the motor housing.

Accordingly, the whole electric drive unit may be attached to the frame within a very brief period of time using one, preferably two or more attachment elements (for example, quick-release thru axles).

This may be performed by a layperson without prior technical knowledge and depending on the embodiment also without tools.

The mounting system enables a non-positive electric drive, wherein the occurring forces can be ideally distributed, supported, and diverted.

The propulsion of the electric drive unit is transmitted via a motor shaft using a chain or belt to the bicycle drive, which is decoupled from the muscle-driven drive by means of a freewheel.

The invention further relates to a mounting system, wherein the drive unit consisting of a motor and controller is non-positively mounted to attachment points provided by the manufacturer by means of a one or two-part adapter using attachment elements, preferably plug-in or screw connections.

In a preferred embodiment the attachment points provided by the manufacturer are formed as flushed sleeves through the frame, through which thru axles, with or without thread, are inserted to fasten the drive unit.

In a further preferred embodiment the attachment points provided by the manufacturer are formed as surficial threads, wherein the drive unit and adapter are fastened using bolts. In a further preferred embodiment the attachment points provided by the manufacturer are formed as rails or guides to which the drive unit may be fastened, preferably with an adapter using bolts or other fastening elements. A battery unit as an energy storage device may be fastened with the same rail system.

In a further preferred embodiment the one or two-part adapter comprises on the drive side of the drive unit a thread or other non-positive seatings for thru axles.

In a further preferred embodiment the two-part adapter comprises on one or both of the parts a thread or other non-positive seatings for thru axles.

In a further preferred embodiment the housing comprising cooling fins serves as a motor seating and may be non-positively connected to the one-part or multi-part, preferably two-part adapter using bolts or other connecting elements.

In a further preferred embodiment the part on the drive side of the two-part adapter is non-positively connected to the motor bolts or is already integrally formed.

### DESCRIPTION OF THE DRAWINGS

In the following, the invention will be explained in more detail with reference to the accompanying figures, which merely provide non-limiting embodiments according to the invention.

FIG. 1 shows an exploded view of an embodiment of the drive system with a mounting system according to the invention;

FIGS. 2 and 3 show a depiction of a further embodiment of the drive system with a mounting system according to the invention from multiple perspectives;

FIGS. 4 and 5 show a depiction of a further embodiment of the drive system with a mounting system according to the invention from multiple perspectives.

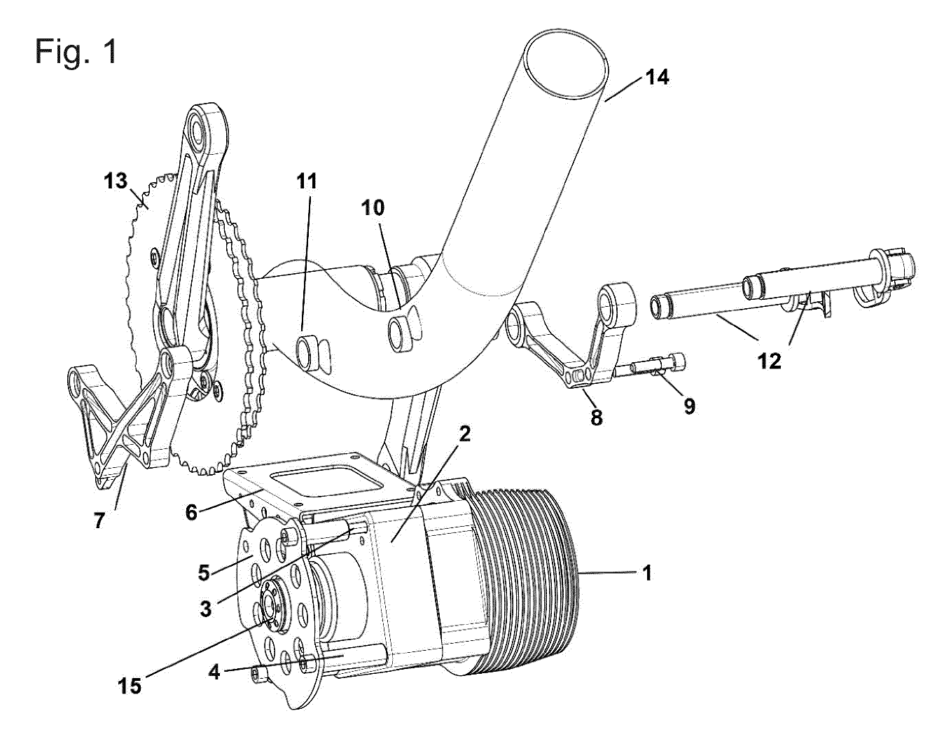

In FIG. 1 a section of a bicycle frame with lower tube (14) is shown, to which a unit of motor (2) and controller (6), with parts such as motor bolts (3), screw sleeves (4), chain cover (5) and motor drive shaft (15) provided therein, is fastened at the attachment points (10, 11) using the adapter consisting of two parts (7, 8) and the quick-release thru axles (12), and wherein the propulsion occurs from the drive shaft (15) to the chain ring of the crankset (13).

The adapter consists of two parts (7, 8), wherein the motor fastening adapter (7) on the drive side is fastened on the motor bolts (3) using screw sleeves (4) and the opposing, in driving direction left-sided adapter (8) is screwed to the housing comprising cooling fins (1) using bolts (9), wherein the housing comprising cooling fins (1) houses and anchors the motor.

The chain cover (5), which is attached to the motor mount, serves to protect against external influences on the rotating drive shaft (15).

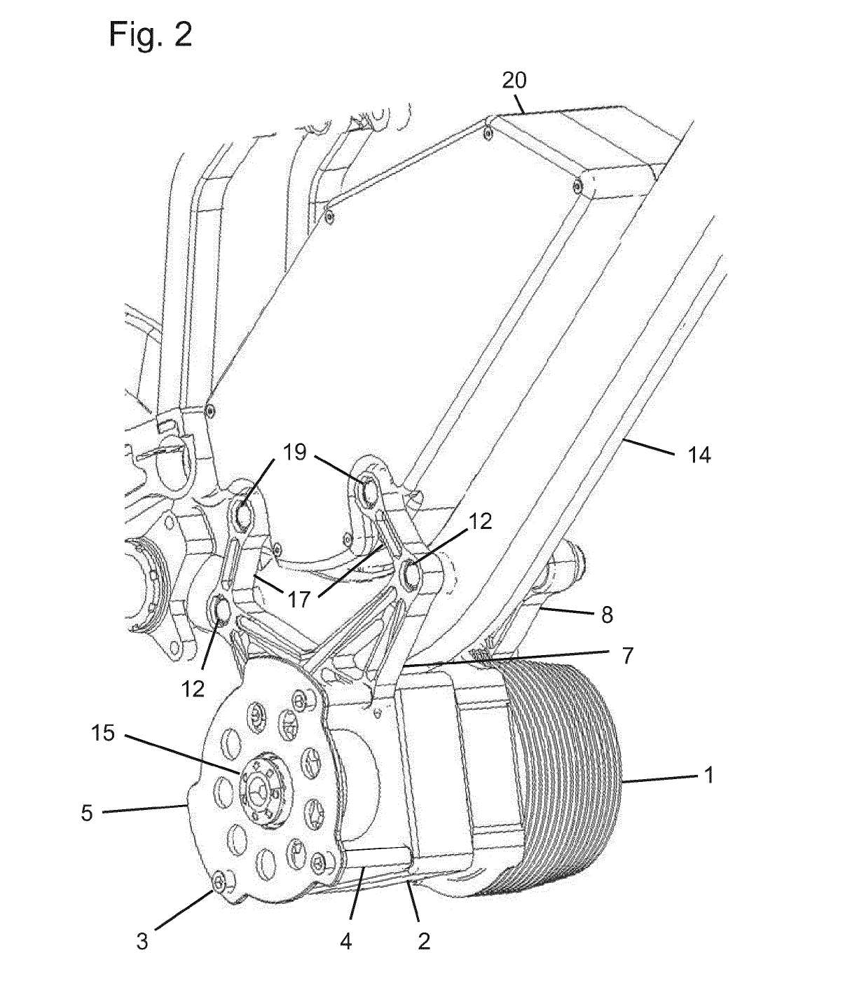

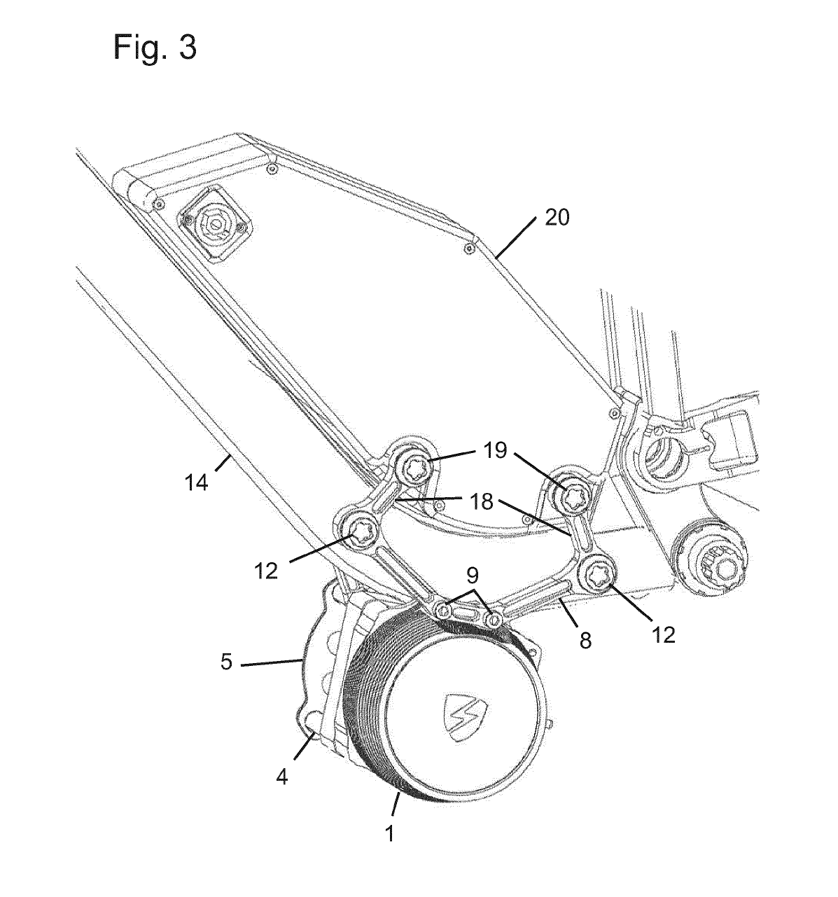

In FIGS. 2 and 3 a further embodiment according to the invention is shown, in which attachment sections (17, 18) are provided on both adapter parts (7, 8) for housing an energy storage device (20), e.g. a battery. In the housing of the battery (20) two through openings are provided, through which two quick-release axles (19) extend for attaching the battery (20) to the attachment sections (17, 18) of the adapter. Accordingly, the battery (20) is permanently connected to the lower tube (14) of the bicycle frame via an adapter, yet remains accessible to, for example, allow a quick replacement of the battery.

The attachment of the motor to the lower tube (14) via both of the adapter parts (7, 8) using quick-release axles (12) corresponds to the embodiment in FIG. 1. The controller is not shown in FIGS. 2 and 3.

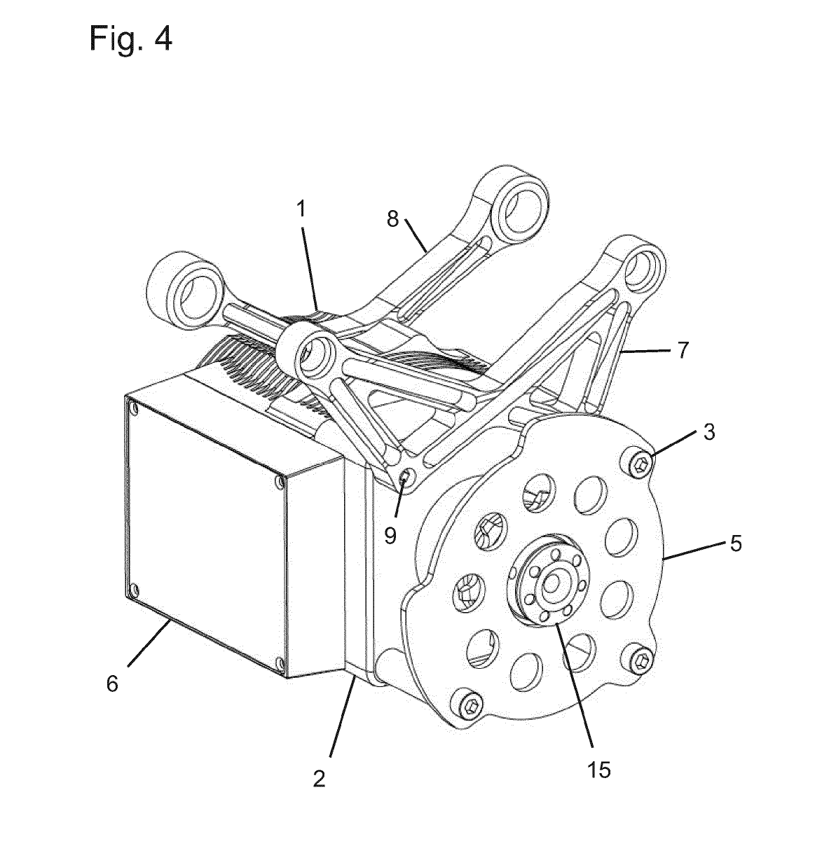

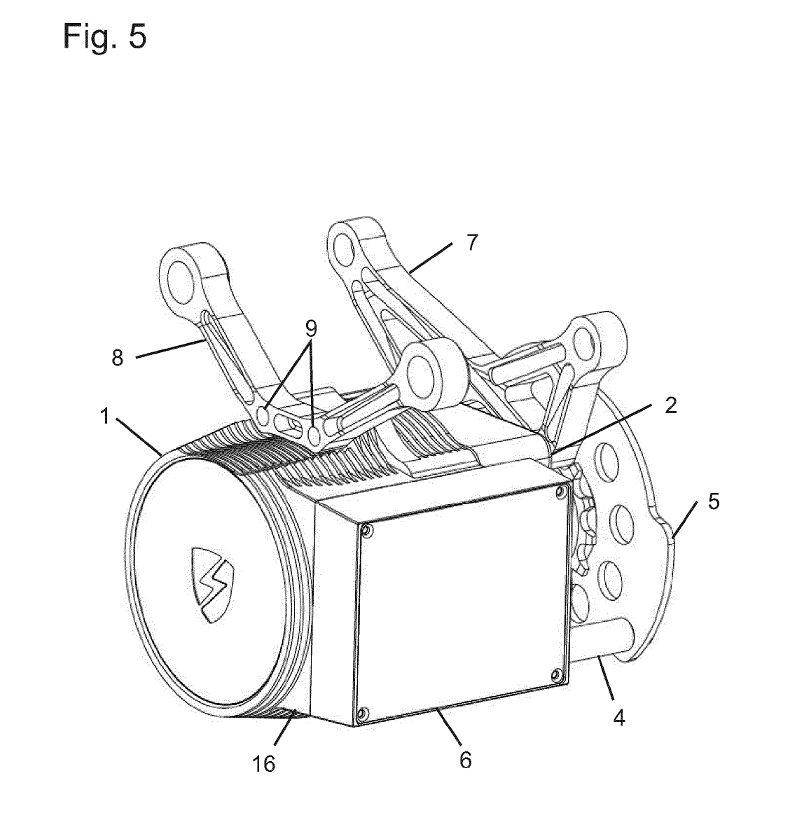

In the embodiment according to FIGS. 4 and 5 it is shown how a controller housing (6) is connected to the motor housing (1, 2). A base (16) is provided on the motor housing (1, 2), which is adjusted to the controller housing (6). The controller housing (6) is attached to the base (16) of the motor housing using bolts. The controller housing (6) may be closed with a lid. Electrical lines may extend from the controller (6) to the motor (2) through an opening (not shown) in the controller housing (6) on the side facing the motor to control the motor.

Also shown in these Figures is how both of the adapter parts (7, 8) are connected to corresponding attachment points on the motor housing (2) using bolts (3, 9).

1. A mounting system to mount a drive unit to a bicycle frame, wherein the mounting system comprises a one or two-part adapter and attachment elements, wherein the adapter is provided with seatings for the attachment elements to non-positively mount the adapter to the attachment points provided on the bicycle frame.

2. The mounting system according to claim 1, wherein the attachment elements comprise thru axles with or without thread, which are formed to be guided through attachment points provided in the bicycle frame as flushed sleeves through the frame.

3. The mounting system according to claim 2, wherein at least several seatings comprise thread for the attachment elements or other non-positive seatings for the thru axles.

4. The mounting system according to claim 1, wherein the attachment elements comprise bolts, which are formed to fasten the adapter on the attachment points provided as surficial thread.

5. The mounting system according to claim 1, wherein the adapter is provided with seatings for fastening elements for non-positive attachment of the drive unit to the adapter.

6. The mounting system according to claim 1, wherein at least one adapter part is integrally formed with a housing of the drive unit.

7. The mounting system according to claim 1, wherein the adapter is provided with seatings for fastening elements for non-positively fastening of an energy storage device on the adapter.

8. A drive system for a bicycle comprising a drive unit with a motor and a controller, wherein the drive system further comprises a mounting system according to claim 1 for mounting the drive unit on a bicycle frame.

9. A mounting system, comprising a drive unit consisting of a motor and a controller that is non-positively mounted to attachment points provided by the manufacturer by means of a one or two-part adapter using attachment elements, preferably plug-in or screw connections.

10. The mounting system according to claim 9, wherein the attachment points provided by the manufacturer are formed as flushed sleeves through the frame, through which thru axles with or without thread may be guided to fasten the drive unit.

11. The mounting system according to claim 9, wherein the attachment points provided by the manufacturer are formed as surficial thread, wherein the drive unit and adapter are fastened using bolts.

12. The mounting system according to claim 9, wherein a one-part adapter comprises a thread or other non-positive seatings for thru axles on the drive side of the drive unit.

13. The mounting system according to claim 9, wherein the two-part adapter comprises a thread or other non-positive seatings for thru axles on one or both of the parts.

14. The mounting system according to claim 9, wherein the housing comprising cooling fins serves as a non-positive motor seating and is non-positively connected to the multi-part, preferably two-part adapter using bolts or other connecting elements.

15. The mounting system according to claim 9, wherein the part on the drive side of the two-part adapter is non-positively connected to the motor bolts or is already integrally formed.
